(19) United States
(12) Patent Application Publication
(10) Pub. No.: US 2019/0085610 A1
(43) Pub. Date: Mar. 21, 2019

(54) COMPARTMENT DAMPER ASSEMBLY

(71) Applicant: Illinois Tool Works Inc., Glenview, IL (US)

(72) Inventors: Philip M. Hamilton, Bourbonnais, IL (US); Lorne K. Turrentine, Chicago, IL (US)

(73) Assignee: Illinois Tool Works Inc., Glenview, IL (US)

(21) Appl. No.: 16/133,788

(22) Filed: Sep. 18, 2018

Related U.S. Application Data
(60) Provisional application No. 62/560,813, filed on Sep. 20, 2017.

(51) Int. Cl. E05F 3/02; F16F 9/02; F16F 9/32

(52) U.S. Cl. CPC E05F 3/02; F16F 9/0281; F16F 2234/02; F16F 2222/126; F16F 2232/08; F16F 9/3242

(57) ABSTRACT

A compartment damper assembly that is configured to vary force on a moveable member of a compartment. The compartment damper assembly includes a housing with an interior chamber. The compartment damper assembly also includes an air regulator system within the interior chamber of the housing. The air regulator system includes a piston movably disposed within the interior chamber of the housing, wherein a first chamber section and second chamber section are formed within the interior chamber, a piston support extending through the piston and including a variable depth slot to allow air to pass between the first chamber section and second chamber section to vary a vacuum force on the piston, and a spring element engaging the piston and the piston support to place a spring force between the piston and piston support.

### RELATED APPLICATIONS

This application relates to and claims the benefit of U.S. Provisional Patent Application No. 62/560,813, entitled “Weight-Independent Damper Assembly” filed Sep. 20, 2017, which is hereby incorporated by reference in its entirety.

### FIELD OF EMBODIMENTS OF THE DISCLOSURE

Embodiments of the present disclosure generally relate to a system and method for opening a cover (such as a door, panel, lid, or the like) of a compartment, and, more particularly, to a compartment damper assembly and method for damping movement of a cover of a compartment from a closed position to an open position.

### BACKGROUND

Various compartments are configured to be selectively opened and closed. For example, a glove compartment within a vehicle is configured to be opened so that one or more items may be stored therein, and then closed to securely retain the item(s). A typical compartment includes a main housing and a cover (such as a door, panel, lid, or the like), or movable member that is moveably secured to the main housing between an open position and a closed position. For example, the cover may be pivotally secured to the main housing. The door includes a damping assembly for damping movement of the cover from the closed position to an open position.

Damping assemblies typically provide a predetermined opening time that depends on the load or weight of and/or on the cover. When loads vary, opening times may similarly vary. More consistency in opening times is desired. Additionally, such consistency is desired within pre-existing spatial constraints, such as within a pre-existing glove compartment and cover system of a vehicle.

### SUMMARY OF EMBODIMENTS OF THE DISCLOSURE

A need exists for a compartment damper assembly that facilitates consistent operation. Further, a need exists for such an assembly that minimizes spatial requirements to achieve the improved functionality.

With those needs in mind, certain embodiments of the present disclosure provide a compartment damper assembly that is configured to vary force on a moveable member of a compartment. The compartment damper assembly includes a housing with an interior chamber and an air regulator system within the interior chamber of the housing. The air regulator system includes a piston movably disposed within the interior chamber of the housing, wherein a first chamber section and second chamber section are formed within the interior chamber. The air regulator system also includes a piston support extending through the piston and including a variable depth slot to allow air to pass between the first chamber section and second chamber section to vary a vacuum force on the piston as the piston moves within the housing, and a spring element engaging the piston and the piston support to place a spring force between the piston and piston support.

The spring element may be configured so that the spring force of the spring element resists the vacuum force. The spring element may also be disposed within the second chamber section of the interior chamber. The second chamber section of the housing may include a spring chamber section for receiving the spring element. The spring chamber section may have a diameter less than the diameter of the piston.

The piston support may be configured to move relative to the piston to vary a size of an orifice formed in the first chamber by the variable depth slot to vary the vacuum force based on load on the piston support. A first sealing element may surround a periphery of the piston and engage the housing to provide an outer seal between the first chamber section and the second chamber section. A second sealing element may be disposed within the piston and surround a periphery of the piston support to provide an inner seal between the first chamber section and the second chamber section. The variable depth slot may be disposed between the second sealing element and a beam of the piston support to allow air to pass from the first chamber section to the second chamber section and past the second sealing element.

The compartment damper assembly may also include a shaft secured to the piston support within the second chamber section of the interior chamber of the housing and configured to be coupled to the moveable member of the compartment. The moveable member may be a door of the compartment. In a first position the shaft may engage the piston to prevent air from passing between the first chamber section and second chamber section through the variable depth slot, and in a second position the shaft may be spaced apart from the piston to allow air to pass between the first chamber section and second chamber section through the variable depth slot.

Certain embodiments of the present disclosure provide a compartment including a main retaining housing defining an internal retaining chamber and a door moveably coupled to the main retaining housing to move from a closed position to an open position. The compartment also includes a compartment damper assembly coupled to one or both of the main retaining housing and the door, the compartment damper assembly being configured to dampen the movement of the door from the closed position to the open position during a predetermined period of time. The compartment damper assembly includes a housing including an interior chamber and an air regulator system within the interior chamber of the housing. The air regulator system includes a piston movably disposed within the interior chamber of the housing, wherein a first chamber section and second chamber section are formed within the interior chamber. The air regulator system also includes a piston support extending through the piston and configured to move relative to the piston to allow air to pass between the first chamber section and second chamber section to vary a vacuum force on the piston as the door moves from the closed position to the open position, and a spring element engaging the piston and the piston support to resist the vacuum force.

### BRIEF DESCRIPTION OF SEVERAL VIEWS OF THE DRAWINGS

FIG. 1 illustrates a perspective front view of a compartment damper assembly with internal portions shown in see-through, according to an embodiment of the present disclosure.

FIG. 2 illustrates a side plan view of the compartment damper assembly of FIG. 1 with internal portions shown in see-through, and with the damper assembly shown in an initial position.

FIG. 3 illustrates a side plan view of the compartment damper assembly of FIG. 1 with internal portions shown in see-through, and with the damper assembly shown in a final position.

FIG. 4 illustrates a partial section view of the compartment damper assembly of FIG. 1, with the damper assembly shown in an initial position.

FIG. 5 illustrates a partial section view of a compartment damper assembly of FIG. 1, after an initial load has moved a shaft away from a piston of the compartment damper assembly.

FIG. 6 illustrates a partial section view of a compartment damper assembly of FIG. 1, as the shaft and piston move together toward a final position.

FIG. 7 illustrates a side cut-away perspective view of a compartment that receives the compartment damper assembly of FIG. 1.

FIG. 8 illustrates a side cut-away perspective view of the compartment damper assembly of FIG. 1 in the compartment of FIG. 7 and coupled to a moveable member.

FIG. 9 illustrates a side cut-away perspective view of the compartment damper assembly of FIG. 1 in the compartment of FIG. 7.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE DISCLOSURE

Embodiments of the present disclosure provide a compartment damper assembly and method that provides a weight independent damper assembly for damping the movement of a moveable member such as a door or lid of a glove box as the moveable member moves from a closed position to an opened position to open within a particular time (such as two seconds). A spring force and variance of a size of the orifice of a passageway disposed between a first chamber section and second chamber section within the housing of the compartment damper assembly control and vary a vacuum force on a piston within the housing. Thus, as the weight on the door of the compartment varies, the size of the orifice similarly varies to vary the vacuum force opposing the movement of the piston. Consequently, a consistent opening time for the door is achieved even as the load on the moveable member increases or decreases.

Compared to known damper assemblies, the compartment damper assembly disclosed provides consistent, stable opening times for a moveable member even as weight or load on the moveable member varies. In addition, because of the simplicity of the design, the compartment damper assembly still can meet spatial requirements for retrofitting into existing compartments. Thus, increased consistency in opening time is achieved without sacrificing spatial characteristics.

Vacuum force when used herein refers to a force resulting from the negative pressure, or negative gage pressure, formed in a sealed or partially sealed chamber as a result of an increase in volume of the chamber by a load, or force. The vacuum force opposes the load.

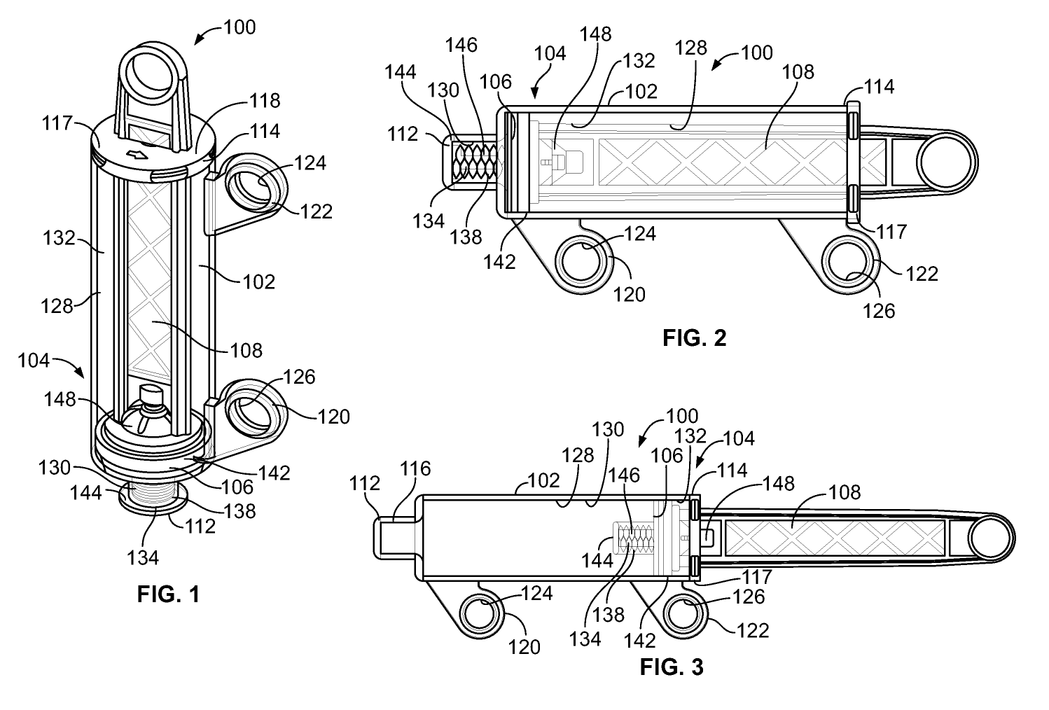

FIG. 1 illustrates a perspective front view of a compartment damper assembly 100, according to an embodiment of the present disclosure. FIG. 2 illustrates a side plan view of the compartment damper assembly 100 in an initial position. FIG. 3 illustrates a side plan view of the compartment damper assembly 100 in a final position. Referring to FIGS. 1-3 the compartment damper assembly 100 includes a housing 102 and an air regulator system 104 including a piston 106 coupled within the housing 102. A shaft 108 is moveably coupled to the piston 106 of the air regulator system 104 and disposed with the housing 102.

The housing 102 includes a first end 112 and a second end 114. A spring chamber section 116 is formed at the first end 112 of the housing 102, wherein the spring chamber section 116 has a diameter less than the rest of the housing 102. In one example, the diameter of the spring chamber section 116 being less than a diameter of the rest of the housing 102 allows the housing 102 with the air regulator system 104 to be placed, or retrofitted into an existing glove box compartment housing to replace an existing compartment damper assembly. In one example embodiment, the second end 114 of the housing 102 receives a removable cap 117 that includes an opening 118 (FIG. 1) therein to accommodate the shaft 108. The cap 117 minimizes air from entering the housing 102 while being removable to allow access to the air regulator system 104 as needed.

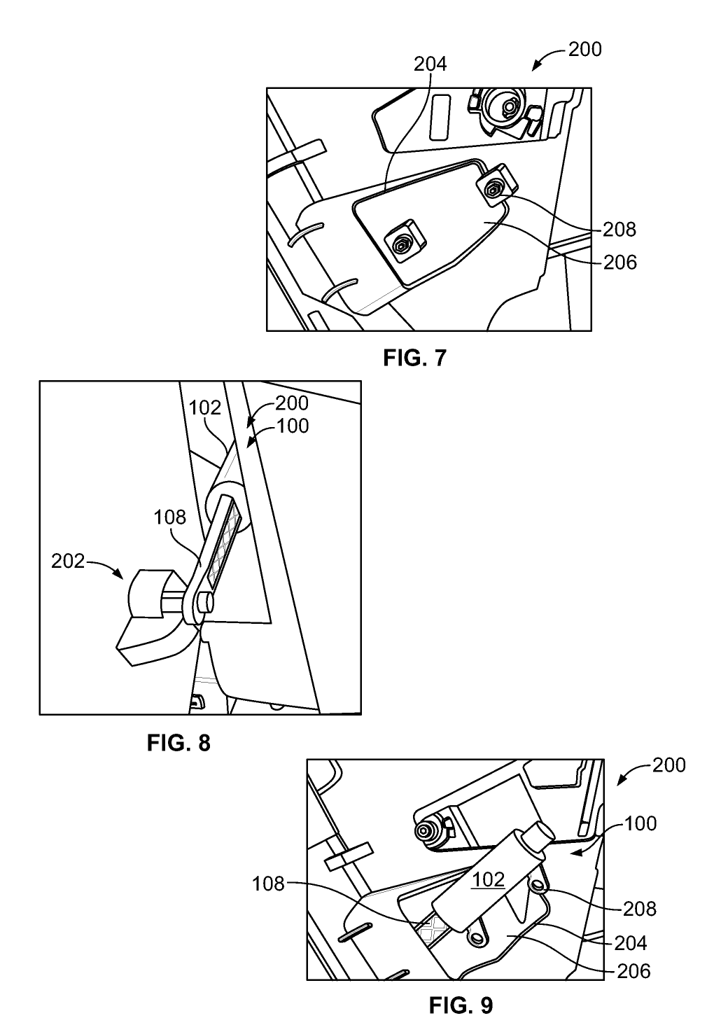

The housing 102 also includes first and second mounting attachments 120, 122 that each include an opening 124, 126 for receiving mounting pins, for example, that are positioned in an interior of a compartment (FIG. 7) in which the compartment damper assembly 100 is to be positioned. To this end, in one example, the openings 124, 126 are spaced to allow the housing to be retrofitted into an existing compartment to replace or be used in place of an alternative compartment damper assembly.

The housing 102 also includes an interior chamber 128 that is divided into a first chamber section 130 and second chamber section 132 by the piston 106. In this manner, as the piston 106 moves toward the first end 112 of the housing 102, the first chamber section 130 decreases in volume and the second chamber section 132 increases in volume. Conversely, as the piston moves toward the second end 114 of the housing 102, the first chamber section 130 increases in volume and the second chamber section 132 decreases in volume. The first chamber section 130 also includes the spring chamber section 116 at the first end 112 of the housing.

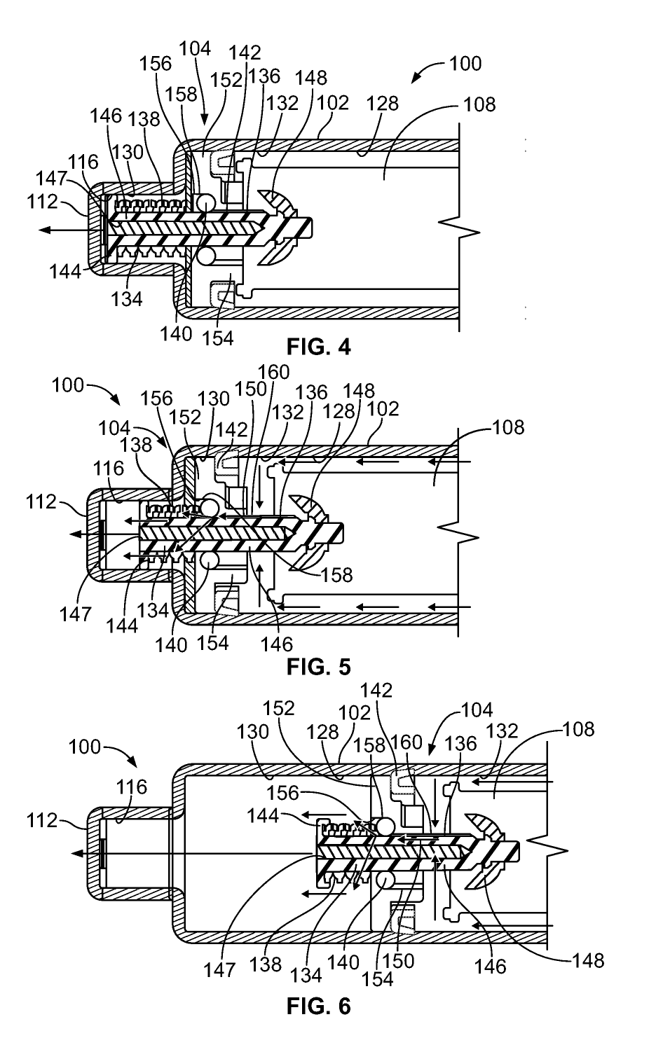

FIG. 4 illustrates a partial section view of an exemplary compartment damper assembly of FIGS. 1-3 in an initial position when no load is on the air regulator system. In an example embodiment, this is when a door of a compartment is in a closed position. FIG. 5 illustrates a partial section view of an exemplary compartment damper assembly of FIGS. 1-3 in an initial load position. In an example embodiment, a door of a compartment is initially opened placing the initial load on the compartment damper assembly to put the compartment damper assembly in this initial load position. FIG. 6 illustrates a partial section view of an exemplary compartment damper assembly of FIGS. 1-3 as the shaft 108 and piston 106 move together toward the final position. In sum, FIGS. 4-6 illustrate the air regulator system 104 and functioning of the air regulator system 104 within the housing 102 through different loading conditions.

With reference to FIGS. 4-6, the air regulator system 104 includes the piston 106, a piston support 134 including a variable depth slot 136, a spring element 138, a first sealing element 140, and a second sealing element 142.

In an example embodiment, the air regulator system 104 includes the piston support 134 that has a head 144 at a first end and a piston support beam 146 extending from the head 144 such that the head 144 forms a flange that is engaged by the spring element 138. The piston support beam 146 includes an air channel 147 centrally located and partially disposed therethrough. The piston support beam 146 extends from the head 144 through the spring element 138, piston 106, and into the shaft 108 wherein the piston support beam 146 secures to the shaft 108 through an attachment mechanism 148 such that, as the piston support 134 moves longitudinally through the interior chamber 128 of the housing, the shaft 108 moves with the piston support 134. A periphery of the piston support beam 146 includes the variable depth slot 136. The variable depth slot 136 is of a length along the support beam 146 such that when the shaft 108 is in a position of non-engagement with the piston 106 (FIGS. 5-6), the variable depth slot 136 extends from within the first chamber section 130 to the second chamber section 132 to provide a fluid communication pathway 150 (FIGS. 5-6) between the first chamber section 130 and second chamber section 132.

The spring element 138 is disposed around the piston support beam 146 and disposed between the head 144 of the piston support 134 and a head 152 of the piston. In this manner the spring element keeps a constant force between the head 144 of the piston support 134 and the head 152 of the piston. In one example, the spring element 138 is a compression spring.

In an example embodiment, the air regulator system 104 also includes the piston 106 that extends from the head 152 to a body 154 that is generally cylindrical such the head 152 forms a flange extending from the body 154. The piston 106 also includes a first cavity 156 disposed within the head 152 and a second cavity 158 that is surrounded by the body 154.

The first sealing element 140 is disposed within the first cavity 156 of the head 152 of the piston 106 and is configured to engage a periphery 158 of the first cavity 156 and engage and surround the piston support beam 146 of the piston support 134. In this manner, the first sealing element 140 seals or prevents the flow of air from the first chamber section 130 to the second chamber section 132 between the piston 106 and piston support 134 except through the variable depth slot 136 that passes by the first sealing element 140. In one example, the first sealing element 140 is an o-ring.

The second sealing element 142 engages the head 152 of the piston 106 and surrounds the body 154 of the piston 106 while also engaging an inner surface of the housing 102. Consequently, the second sealing element 142 prevents the flow of air between the piston 106 and the housing 102 from the first chamber section 130 of the housing 102 to the second chamber section 132 of the housing 102.

The shaft 108, as described above, receives and is secured to the piston support 134 via an attachment mechanism 148. In the first position, or initial position, when no load is on the air regulator assembly 104, as illustrated in FIG. 4, the shaft 108 engages the body 154 of the piston 106. In response to an initial load, as illustrated in FIG. 5, the shaft 108 moves away from the first end 112 of the housing and separates from the piston 106 to move to a second position. The second position as illustrated in FIG. 5 represents the maximum distance the shaft 108 separates from the piston 106 before the shaft 108 and piston 106 begin moving together as a result of the air flow through the pathway 150. Thus, the second position of the piston 106 varies based on the initial load to vary the movement of the shaft 108 such that the shaft 108 moves at the same rate even as the initial load varies.

The separation from the piston 106 from the shaft 108 forms an orifice 160 in the second chamber section 132 to provide the pathway 150 from the second chamber section 132 to the first chamber section 130 via the variable depth slot 136. Therefore, the distance the shaft 108 separates from the piston 106 in response to the initial load, and thus the size of the orifice 160, is dependent on the size of the load and is regulated, or is dependent on the spring element 138. In one example, the size of the load is based on the amount of weight on a door of a compartment coupled to the shaft 108. Thus, the size of the load determines the size of the orifice 160 formed by the variable depth slot 136 within the second chamber section 132. Specifically, as the piston 106 moves away from the first end 112 of the housing 102 toward the second end 114 of the housing 102, a vacuum force forms within the first chamber section 130 that resists the movement of the piston 106 by providing a force in the opposite second direction. Therefore, the amount of air flowing through the pathway 150 to the first chamber 130 varies this vacuum force based on load size, or the weight on the door of the compartment. Consequently, the vacuum force is varied by the compartment damper system 100 to provide more consistent, and in one example, the same opening time for the door of the compartment over a range of pre-determined weights, or loads, on the door. In one example, this opening time is about two (2) seconds. In another example this consistent opening time is in a range between about 1.8 seconds and about 2.2 seconds for loads in a range between 0 and 20 lbs. In this manner, the compartment damper system 100 is considered a weight-independent damper assembly.

The air regulator system 104 includes the piston support 134, which holds the piston 106 and spring element 138 in place. The piston 106 holds two types of sealing elements 140, 142, or seals, effectively sealing off one part of the housing from the other part of the housing. In other words, the first and second sealing elements 140, 142 seal the first chamber section 130 from the second chamber section 132. The variable depth slot 136 is provided along a length of a beam 146 of the piston support 134. The variable depth slot 136 creates a pathway 150 in the system 104 through which air from the second chamber section 132 of the housing 102 can pass into the first chamber section 130.

The spring element 138 is located behind the piston 106 toward the rear, or first end 112 of the housing 102 and provides a reactive force in order to keep the piston 106 from sliding rearward immediately upon an initiating force. The location of the piston 106 relative to the piston support 134 is determined by the force applied by the unit being damped and the force of a vacuum created by the movement of the system. The vacuum force would, if not for the spring element 138, pull the piston toward the first end 112 or rear of the housing 102, or unit, relative to the shaft 108. Due to the spring force acting as a reactive force to the vacuum, the air passage through the variable depth slot 136 is regulated due to the slot size between the first seal element 140 coupled to the piston 106 and the variable depth slot 136 of the piston support 134.

FIG. 7 illustrates a side cut-away perspective view of a compartment 200 without a compartment damper assembly 100. FIG. 8 illustrates a side cut-away perspective view of a compartment 200 with a compartment damper assembly 100 in a first or closed position according to an embodiment of the present disclosure. FIG. 9 illustrates a back cut-away perspective view of a compartment 200 with a compartment damper assembly 100 in a second or open position according to an embodiment of the present disclosure.

FIGS. 7-9 illustrate the compartment 200 that includes a cover, for example, a moveable member 202 such as a door (FIG. 8). The moveable member 202 is pivotally coupled to a main retaining housing 204, which defines an internal retaining chamber 206. The compartment damper assembly 100 is coupled to the moveable member 202 (FIG. 8) and secured to at least one mounting pin 208 (FIG. 7). While in this embodiment a mounting pin 208 is utilized, in other examples, other mounting structures may be utilized, including brackets, fasteners, welds, and the like. In particular, because of the design of the compartment damper assembly 100 minimizing the number of parts required to provide the weight independent opening, spatially, the housing 102 may be easily adjusted to retrofit into existing compartments 200.

Thus, the compartment damper assembly 100 includes the shaft 108 that is coupled to a structure, such as the door 202 of the compartment 200, for example, a glove box. At least a portion of the compartment damper assembly 100 is configured to move with the shaft 108 that is attached to the moveable member 202, the motion of which is damped by the damper assembly 100.

The damper assembly 100 thus provides a variable force damper that may vary an opening time based upon the force applied to the system by the unit being damped, such as through the air regulatory system 104 contained within the housing 102 of the damper assembly 100 and attached to the main shaft 108. The main shaft 108 is attached to the unit that is to be damped (such as a moveable door or bin of a glove box), while the housing 102 is attached to a stationary point outside of the system (such as a fixed compartment of the glove box).

Embodiments of the present disclosure provide the compartment damper assembly 100 that is configured to vary force on the moveable member 202 of a compartment 200. The compartment damper assembly 100 includes the housing 102 with the interior chamber 128 and the air regulator system 104 within the interior chamber 128 of the housing 102. The air regulator system 104 includes the piston 106 movably disposed within the interior chamber 128 of the housing 102 to form the first chamber section 130 and the second chamber section 132. The air regulator system also includes the piston support 134 extending through the piston 106 and including the variable depth slot 136 to allow air to pass between the first chamber section 130 and the second chamber section 132 to vary the vacuum force on the piston 106, and the spring element 138 engaging the piston 106 and the piston support 136 to place the spring force between the piston 106 and the piston support 134.

The compartment damper assembly 100 includes the air regulator system, which provides a weight independent adjusted opening, to provide consistent opening times. The compartment damper assembly 100 provides an efficient and relatively simple assembly providing spatial requirement for retrofitting into existing compartments.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure. The embodiments described herein explain the best modes known for practicing the disclosure and will enable others skilled in the art to utilize the disclosure. The claims are to be construed to include alternative embodiments to the extent permitted by the prior art.

To the extent used in the appended claims, the terms “including” and “in which” are used as the plain-English equivalents of the respective terms “comprising” and “wherein.” Moreover, to the extent used in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

Various features of the disclosure are set forth in the following claims.

1. A compartment damper assembly that is configured to vary force on a moveable member of a compartment, the compartment damper assembly comprising:
a housing including an interior chamber; and
an air regulator system in fluid communication with the interior chamber of the housing, the air regulator system comprising:
a piston movably disposed within the interior chamber of the housing, wherein a first chamber section and second chamber section are formed within the interior chamber;
a piston support extending through the piston and including a variable depth slot to allow air to pass between the first chamber section and second chamber section to vary a vacuum force on the piston; and
a spring element engaging the piston and the piston support to place a spring force between the piston and piston support.

2. The compartment damper assembly of claim 1, wherein the spring element is configured so that the spring force of the spring element resists the vacuum force.

3. The compartment damper assembly of claim 2, wherein the piston support is configured to move relative to the piston to vary a size of an orifice formed in the first chamber by the variable depth slot to vary the vacuum force based on load on the piston support.

4. The compartment damper assembly of claim 1, wherein the spring element is disposed within the second chamber section of the interior chamber.

5. The compartment damper assembly of claim 4, wherein the second chamber section of the housing includes a spring chamber section for receiving the spring element, the spring chamber section having a diameter less than a diameter of the piston.

6. The compartment damper assembly of claim 1, the air regulator system further comprising a first sealing element disposed within the piston and surrounding a periphery of the piston support to provide an inner seal between the first chamber section and the second chamber section.

7. The compartment damper assembly of claim 6, the air regulator system further comprising a second sealing element surrounding a periphery of the piston and engaging the housing to provide an outer seal between the first chamber section and the second chamber section.

8. The compartment damper assembly of claim 6, wherein the variable depth slot is disposed between the first sealing element and a beam of the piston support to allow air to pass from the first chamber section to the second chamber section and past the first sealing element.

9. The compartment damper assembly of claim 1, further comprising:
a shaft secured to the piston support within the second chamber section of the interior chamber of the housing and configured to be coupled to the moveable member of the compartment.

10. The compartment damper assembly of claim 9, wherein the moveable member is a door of the compartment.

11. The compartment damper assembly of claim 9, wherein in a first position the shaft engages the piston to prevent air from passing between the first chamber section and second chamber section through the variable depth slot, and in a second position the shaft is spaced apart from the piston to allow air to pass between the first chamber section and second chamber section through the variable depth slot.

12. A compartment comprising:
a main retaining housing defining an internal retaining chamber;
a door moveably coupled to the main retaining housing to move from a closed position to an open position; and
a compartment damper assembly coupled to one or both of the main retaining housing and the door, the compartment damper assembly being configured to dampen the movement of the door from the closed position to the open position during a predetermined period of time, the compartment damper assembly comprising:
a housing including an interior chamber;
an air regulator system within the interior chamber of the housing, the air regulator system comprising:
a piston movably disposed within the interior chamber of the housing, wherein a first chamber section and second chamber section are formed within the interior chamber;
a piston support extending through the piston and configured to move relative to the piston to allow air to pass between the first chamber section and second chamber section to vary a vacuum force on the piston as the door moves from the closed position to the open position; and
a spring element engaging the piston and the piston support to resist the vacuum force.

13. The compartment of claim 12, wherein the piston support includes a variable depth slot disposed therethrough that allows the air to pass between the first chamber section and second chamber section.

14. The compartment of claim 13, further comprising:
a shaft coupled to the door and secured to the piston support such that the shaft and piston support move relative to the piston.

15. The compartment of claim 14, wherein as the door moves from the closed position to the open positing the shaft is configured to move from a first position in engagement with the piston to a second position spaced from the piston.

16. The compartment of claim 15, wherein as the shaft moves from a first position to the second position, the variable depth slot forms an orifice within the first chamber section of the housing.

17. The compartment of claim 16, wherein a size of the orifice formed by the variable depth slot varies based on an initial load that moves the shaft from the first position of the shaft relative to the piston to the second position of the shaft relative to the piston.

18. A compartment damper assembly that is configured to vary force on a moveable member of a compartment, the compartment damper assembly comprising:
a housing including an interior chamber;
an air regulator system within the interior chamber of the housing, the air regulator system comprising:
a piston movably disposed within the interior chamber of the housing, wherein a first chamber section and second chamber section are formed within the interior chamber;
a piston support extending through the piston and including a variable depth slot that extends from a first end of the piston support to a second end to allow air to pass between the first chamber section and second chamber section in response to a load on the piston support to vary a vacuum force on the piston, the variable depth slot forming an orifice within the first chamber section in response to the load on the piston support; and
a spring element engaging the piston and the piston support to place a spring force between the piston and piston support that resists the vacuum force;
a sealing element surrounding a periphery of the piston support and surrounding the variable depth slot to allow air to pass from the first chamber section to the second chamber section and past the sealing element.

19. The compartment damper assembly of claim 18, further comprising:
a shaft moveably disposed within the interior chamber of the housing and secured to the piston support to provide the load on the piston support, the shaft engaging the piston in a first position and spaced from the piston in a second position.

20. The compartment damper assembly of claim 19, wherein the orifice within the first chamber section is formed as the shaft moves from the first position to the second position.
